(19) United States
(12) Patent Application Publication
(10) Pub. No.: US 2014/0227617 A1
(43) Pub. Date: Aug. 14, 2014

(54) System and method for managing water generated by fuel cells

(71) Applicants: Vasilios Dossas, Chicago, IL (US); Clifford H. Kraft, Naperville, IL (US); Laura Zimmerman, Mendota, IL (US)

(72) Inventors: Vasilios Dossas, Chicago, IL (US); Clifford H. Kraft, Naperville, IL (US); Laura Zimmerman, Mendota, IL (US)

(21) Appl. No.: 14/177,256

(22) Filed: Feb. 11, 2014

Related U.S. Application Data
(63) Continuation of application No. 10/454,864, filed on Jun. 5, 2003, now abandoned.

(51) Int. Cl. H01M 8/04; H01M 8/06

(52) U.S. Cl. CPC H01M 8/04291; H01M 8/0656
USPC 429/410; 429/414; 429/422

(57) ABSTRACT

A system and method for managing water produced by fuel cells where this waste water is captured and used for agricultural, industrial or community purposes along with electricity generated by the fuel cells. Water from a coastal (or lake coast) region can be converted by electricity into hydrogen and oxygen gas or hydrogen and chlorine gas with the hydrogen gas being piped to remote regions for conversion into fresh water and electricity by fuel cells. The oxygen or chlorine can be optionally recovered.

This is a continuation of application Ser. No. 10/454,864 filed Jun. 5, 2003. application Ser. No. 10/454,864 is hereby incorporated by reference in its entirety.

### BACKGROUND

1. Field of the Invention

The present invention relates generally to the field of managing water and more particularly to a system and method for managing water generated by fuel cells.

2. Discussion of the Prior Art

Hydrogen fuel cells produce electricity from a controlled reaction of hydrogen gas and oxygen from the air. A byproduct of this reaction is water.

Prior art methods and systems have simply discharged this water as a waste product without making use of it. For example, hydrogen powered vehicles are known to discharge water vapor into the atmosphere. While this practice is not necessarily harmful to the environment, it overlooks the fact that in many regions of the earth water is scarce.

In addition, it is a common practice to generate electricity at locations where there is an abundance of water and then transmit the generated power to possibly more arid regions via a power grid. Water is needed near power generators for two purposes: 1) as an energy source in hydroelectric systems, and 2) for cooling in and steam generation in nuclear and coal or gas-fired plants. However, this scheme, while providing electricity to arid regions, does nothing to solve the need for fresh water.

A need exists to provide water for arid regions as well as dispose of waste water from fuel cells. Additionally, arid regions require both water and electricity. A system and method is needed that can simultaneously solve these problems.

### SUMMARY OF THE INVENTION

The present invention relates to a method of managing water generated by one or more fuel cells which captures the water generated by the fuel cell; stores said water; and distributes the stored water to locations remote from the fuel cell. The present invention uses the water for agriculture, drinking water, water for industry and for any other purpose. The electricity from the fuel cells can also be used for agriculture, private consumption or industry.

The present invention also relates to a system for managing water produced by fuel cells using an electrolysis plant located in a coastal region where the electrolysis plant converts water into hydrogen gas directly. If the water is fresh, the electrolysis plant produces hydrogen and oxygen gas. The oxygen can optionally be recovered. If the water is sea water, the electrolysis plant can produce hydrogen and chlorine gas where the chlorine is optionally recovered or can be run in tandem with a distillation plant that converts the sea water to fresh water and optionally recovers minerals from the sea water. In addition, the present invention relates to a hydrogen gas pipeline running between said electrolysis plant and a predetermined region spaced a substantial distance from said electrolysis plant. This hydrogen pipeline could be constructed and managed like a natural gas pipeline. In the remote or predetermined region, hydrogen fuel cells can be located in a power generating location receiving said hydrogen gas from the pipeline. These fuel cells can produce both fresh water and electric power for the region. The water can be stored and then distributed for agriculture, industry or private use. The electric power can likewise be distributed.

### DESCRIPTION OF THE DRAWINGS

Several illustrations are presented to clarify and explain the present invention. The present invention is not limited to the embodiments illustrated.

FIG. 1 is a schematic diagram of a hydrogen fuel cell showing how the cell functions to produce both electricity and water.

FIG. 2 shows water recovery from a fuel cell stack.

FIG. 3 shows schematically hydrogen and air entering a fuel cell power plant to produce electricity and water.

FIG. 4 shows a community using water from a fuel cell power plant.

FIG. 5 shows water from a fuel cell power plant being used for agriculture.

FIG. 6 shows a grid map of the U.S. southwest showing piping hydrogen from California to Nevada and Arizona.

FIG. 7 shows a schematic diagram of a power cycle where hydrogen is produced from sea water in a coastal region and piped to an arid region to produce both electricity and water.

Various drawings and illustrations have been provided to aid understanding of the present invention. It should be understood that the scope of the present invention is not limited to the drawings.

### DESCRIPTION OF THE INVENTION

The present invention relates to a system and method of recovering water from hydrogen fuel cells and using it as drinking water in communities near a power plant and for agriculture. The present invention also relates to producing hydrogen gas in a region where there is an abundance of water; piping the gas to an arid region, and there using the gas in hydrogen fuel cells to produce both electricity and water.

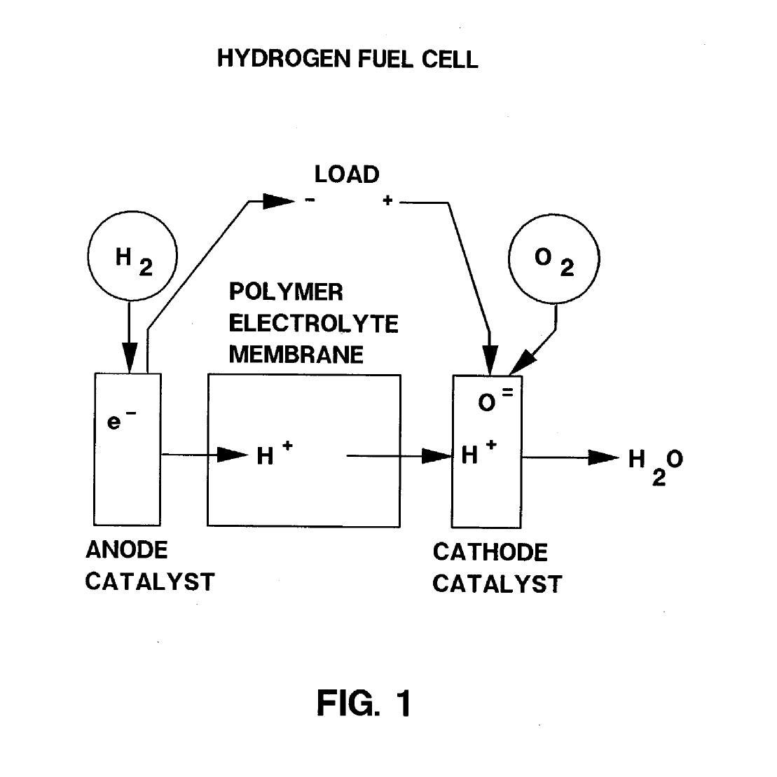

Hydrogen fuel cells are devices that mix hydrogen gas and air to through a polymer electrolyte membrane to produce electricity. The chemical reaction where hydrogen and oxygen are combined is known to produce water as a bi-product. As shown in FIG. 1, a fuel cell includes an anode and cathode made of specialized catalytic materials. These electrodes are separated by a polymer membrane. Hydrogen gas enters the catalytic area of the anode where it is ionized. Hydrogen ions are pulled through the membrane by electrostatic forces where they combine with oxygen from air at the cathode to produce water. The reaction (which using free gasses is explosive) is controlled. A DC voltage appears between the anode and cathode with current capability that depends on the size and construction of the fuel cell.

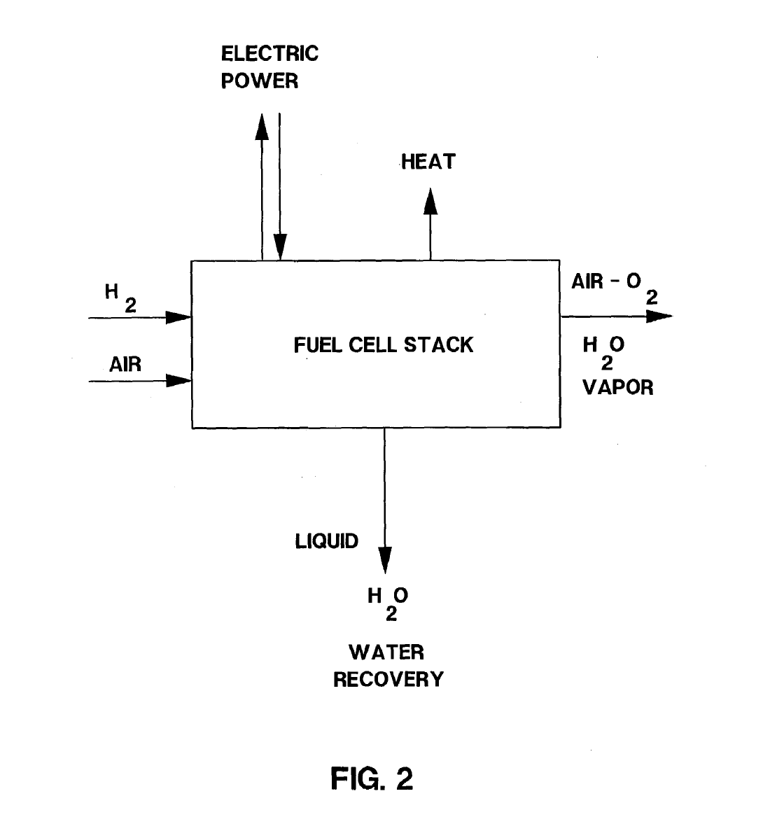

Stacking fuel cells as shown in FIG. 2 yields DC power of any arbitrary voltage and current. Power plants can be built that supply either DC directly to users, or convert the DC to AC by invertors or oscillators and transform it to a desired voltage at 50 or 60 Hz. The bi-products of such power production are heat, nitrogen (air with some oxygen removed), and water. The purity of the water depends on the catalysts used and the amount of chemical displacement into the water from the electrodes and catalysts. In modern fuel cells, the discharged water is pure enough to drink without further processing. Of course the water can be further processed if necessary. For drinking water supplies, it may be desirable to chlorinate the water to kill any possible bacteria and plant material (fungus). Agricultural water, on the other hand, needs no further processing. In any case, the process in the fuel cell itself is that shown in FIG. 1.

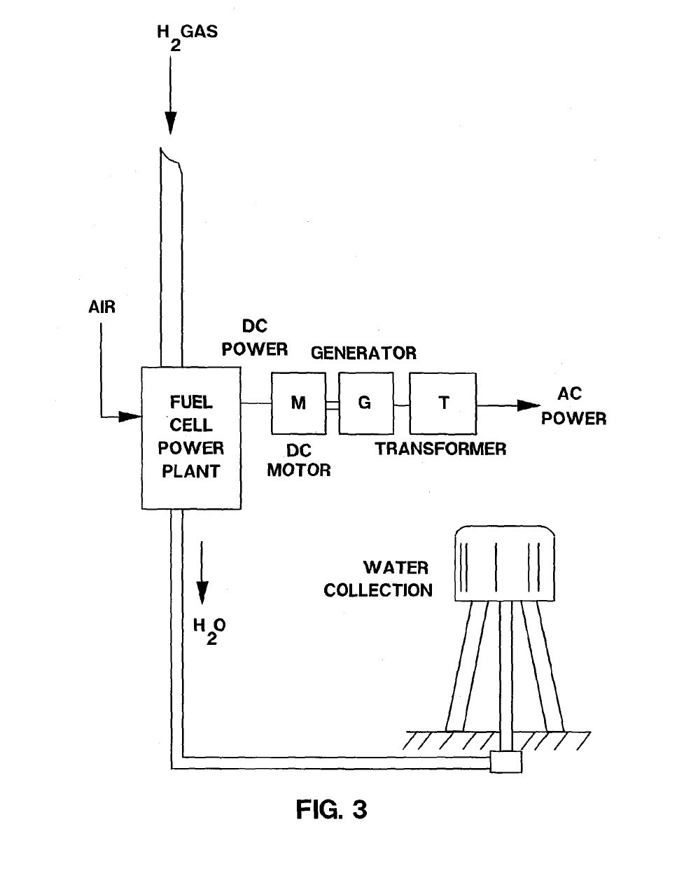

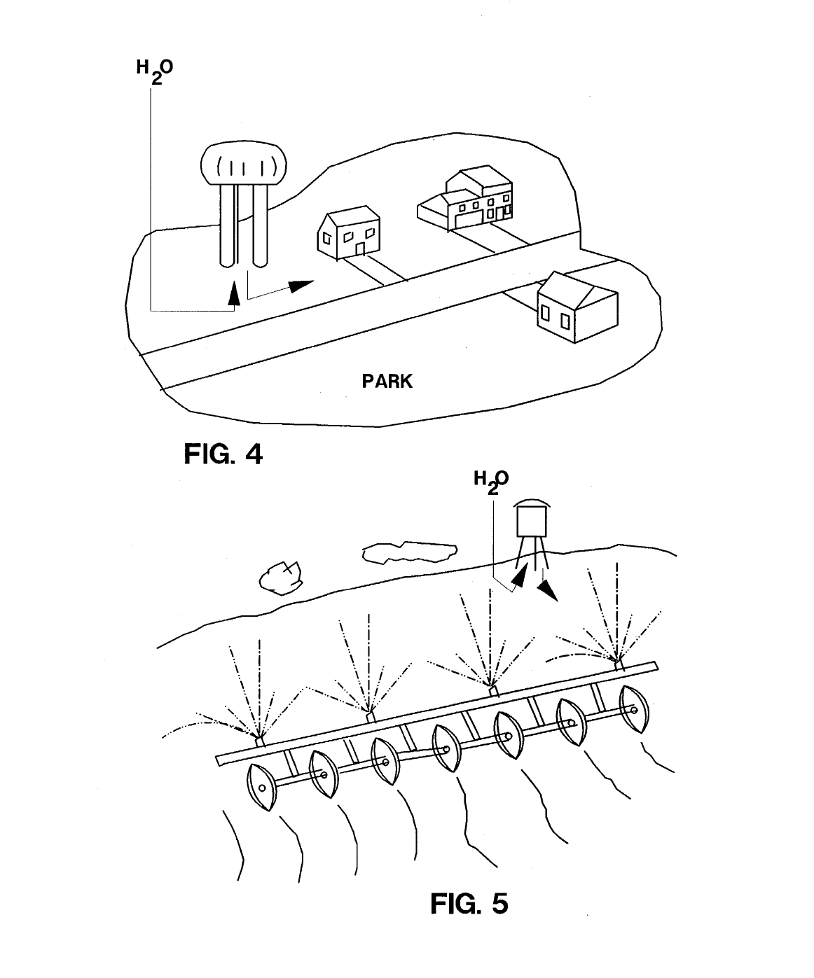

Tuning to FIGS. 3, 4 and 5 the use of fuel cells in communities to both generate electricity and supply water can be seen. Using the process depicted in FIGS. 1 and 2, a fuel cell plant takes in air and supplied hydrogen gas and puts out water and DC power. The water can be pumped or otherwise transferred to holding tanks. For agricultural use such as shown in FIG. 5, the water can be used directly; for community use such as shown in FIG. 4, the water should usually be further purified in terms of removing any chemicals that might have entered the water from the fuel cell and killing any bacteria or plant life that might exist in pipes and tanks. Usually a standard chlorine treatment is sufficient to make the water potable. Because very few minerals are found in fuel cell generated water, softening is not usually necessary.

Direct current (DC) electricity can be converted to alternating current by various methods, one of which is shown in FIG. 3. In this example, direct current from a fuel cell or fuel cell stack drives a motor-generator tandem to produce alternating current (AC) at a controllable amplitude and frequency. A transformer can optionally be used to change voltage for transmission. Many other ways can be used to transform DC to AC including inversion and oscillator methods. It is also very feasible to use DC directly in many cases (especially for lighting and heating).

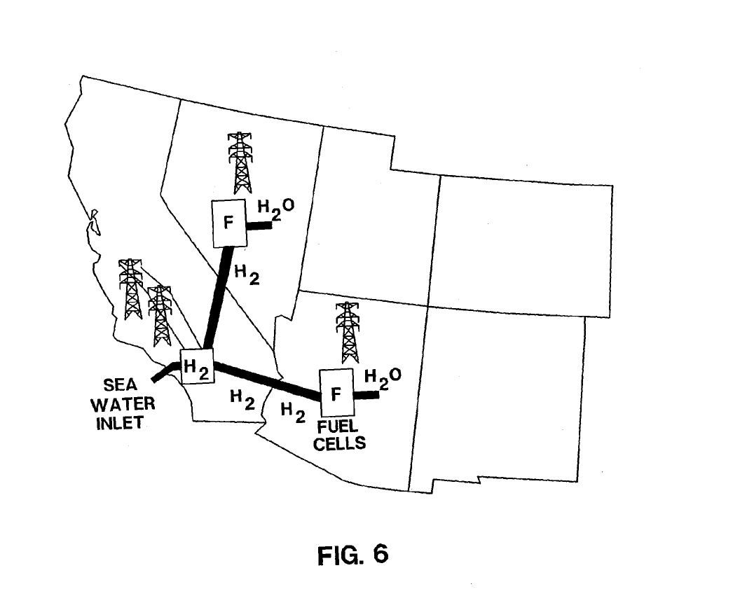

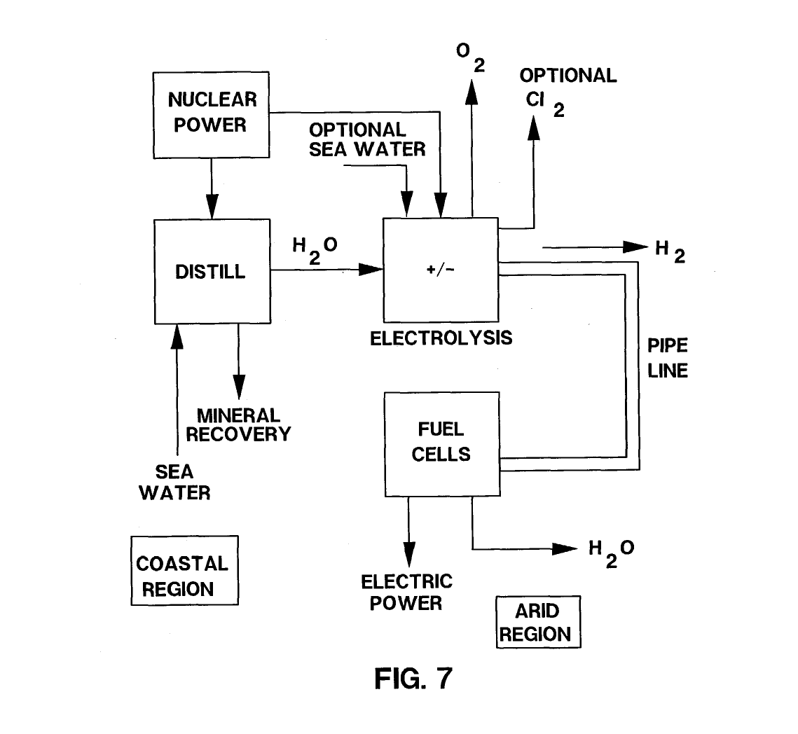

One of the major problems solved by the present invention is simultaneously supplying water and electricity to arid lands. FIGS. 6 and 7 show an embodiment of the present invention that solves this problem. In FIG. 6, a hydrogen gas generating plant is located near a coast such as southern California. Nuclear generated electricity (or electricity generated by any means) is supplied to the hydrogen plant. If a plant is located near a body of fresh water (such as near one of the Great Lakes), the water can be directly converted into hydrogen and oxygen by a standard electrolytic process. If, on the other hand, the hydrogen plant is near the ocean such as in FIG. 6, the sea water must usually first be distilled to remove salt and other minerals. These recovered salts and minerals can be re-cycled and used as a valuable side product of the process. In general, electricity could be used to provide the heat to distill the water, either as part of the direct cooling of a nuclear power plant or in a separate operation.

The distilled sea water (or original fresh water) can then be converted to hydrogen and oxygen by the electrolytic process. The oxygen produced could be purified, compressed and used commercially or medically, or it could be safely released into the atmosphere. The hydrogen gas could enter a gas pipeline and be transferred much as natural gas is transferred to arid areas such as Arizona or Nevada as shown in FIG. 6. A hydrogen pipeline could be constructed and managed much as a natural gas pipeline. Leakage by hydrogen penetration could be controlled by using various pipe jacket technologies. Once the hydrogen reaches the arid area, it can be converted to water and electricity as previously described.

FIG. 7 shows the process schematically. Nuclear power, or any other source of electricity, is used to distill sea water into fresh water with secondary mineral and salt recovery. The fresh water is converted to hydrogen and oxygen gas by electrolysis. The hydrogen gas can be piped to remote regions just like natural gas. Fuel cells in the remote regions use air to convert the hydrogen to electricity and water. The water can be used for agricultural, industrial or community purposes along with the generated electricity. It should be noted that it is not necessary to distill sea water to produce hydrogen gas by electrolysis. Direct electrolysis of sea water produces hydrogen and chlorine gases. In any case, the oxygen or chlorine produced by electrolysis can be optionally recovered.

Several descriptions and embodiments of the present invention have been presented. It will be recognized by one skilled in the art that numerous changes and variations are within the scope and spirit of the present invention. One skilled in the art will also recognize that there are numerous other ways to operate the present invention that have not been presented here but which are within the scope of the present invention.

We claim:

1. A method of managing water generated by one or more fuel cells, said method comprising the steps of:
(a) capturing the water generated by the fuel cell;
(b) storing said water;
(c) distributing the stored water to a plurality of locations remote from the fuel cell.

2. The method of claim 1 wherein said water is used for agriculture.

3. The method of claim 1 wherein said water is used as drinking water.

4. The method of claim 1 wherein said water is used for industry.

5. A system for managing water generated by one or more fuel cells, said system comprising:
(a) one or more fuel cells for generating electrical power and water;
(b) one or more water storage containers for receiving the water generated by the fuel cells;
(c) first conduit means for connecting the fuel cells with the storage container and conveying water between the fuel cells and the storage container;
(d) second conduit means for carrying water from the storage container to a plurality of locations remote from said fuel cells.

6. The system of claim 5 wherein said water is used for agriculture.

7. The system of claim 5 wherein said water is used as drinking water.

8. A system for managing water produced by fuel cells comprising:
an electrolysis plant located in a coastal region, said electrolysis plant converting water into hydrogen gas;
a hydrogen gas pipeline between said electrolysis plant and a predetermined region spaced a substantial distance from said electrolysis plant;
at least one hydrogen fuel cell located in said predetermined region receiving said hydrogen gas from said pipeline;
said hydrogen fuel cell producing fresh water and electric power from said hydrogen gas for said predetermined region.

9. The system for managing water produced by fuel cells of claim 8 wherein said electrolysis plant converts fresh water into hydrogen and oxygen gas.

10. The system for managing water produced by fuel cells of claim 9 further comprising a distilling plant located near said electrolysis plant for converting sea water to fresh water.

11. The system for managing water produced by fuel cells of claim 10 further comprising recovering minerals from said sea water.

12. The system for managing water produced by fuel cells of claim 9 further comprising recovering oxygen gas from said electrolysis plant.

13. The system for managing water produced by fuel cells of claim 8 further comprising said electrolysis plant converting sea water to hydrogen and chlorine gas.

14. The system for managing water produced by fuel cells of claim 13 further comprising recovering said chlorine gas.

15. The system for managing water produced by fuel cells of claim 8 wherein said fresh water produced by said plurality of fuel cells is used for agriculture in said predetermined region.

16. The system for managing water produced by fuel cells of claim 8 wherein said fresh water produced by said plurality of fuel cells is used as drinking water in said predetermined region.

17. The system for managing water produced by fuel cells of claim 8 wherein said fresh water produced by said plurality of fuel cells is used as industrial water in said predetermined region.
